(19) United States
(12) Patent Application Publication
(10) Pub. No.: US 2019/0377699 A1
(43) Pub. Date: Dec. 12, 2019

(54) ANALOG INDUSTRIAL CONTROL SYSTEMS ANTI-DETECTION ARCHITECTURE AND METHOD

(71) Applicant: Chin-Hui LIANG, New Taipei (TW)

(72) Inventor: Chin-Hui LIANG, New Taipei (TW)

(21) Appl. No.: 16/546,683

(22) Filed: Aug. 21, 2019

Related U.S. Application Data
(63) Continuation-in-part of application No. 15/711,519, filed on Sep. 21, 2017, now abandoned.

(30) Foreign Application Priority Data
Apr. 13, 2017 (TW) 106205162

(51) Int. Cl. G06F 13/40; G06F 15/173

(52) U.S. Cl. CPC G06F 13/4022; G06F 15/173

(57) ABSTRACT

An electronic signal transmission control system and method thereof comprising a plurality of hosts connected to a transmission control system. The plurality of hosts respectively connect with a plurality of command data modules and provide execution command data to corresponding address conversion modules. The command data is converted into an electronic signal and is provided to a processing module for analysis and integration. The integrated electronic signal is transmitted to an application interface module. A data processing module receives an execution command issued by an external device. The execution command is analyzed and then transmitted to a control engine module for integration. The external device transmits the data signal via a system hub module

### CROSS-REFERENCE TO RELATED APPLICATION

This application claims priority to and is a continuation-in-part of U.S. patent application Ser. No. 15/711,519, filed Sep. 21, 2017, the content of which is incorporated herein by reference in its entirety.

### BACKGROUND OF THE INVENTION

### Field of the Invention

The present invention relates to an electronic signal transmission control system; and more particularly to an external device for transmitting data to multiple host receivers at the same time, and simplifying the switching between multiple hosts.

### Description of the Prior Art

The rate of computer usage is continually increasing internationally since there is need to use computer equipment in all walks of life. Currently, using a host with multiple monitors is quite popular. However, there are still many improvements that need to be made in order to efficiently perform the switching of multiple displays by a single computer. If a single computer needs to be connected to multiple displays to perform display functions, typically:

Each display is directly connected to the host computer, and the screen of the host computer is displayed simultaneously on each display;

Each display is directly connected to the host computer, and each display is mounted into an large display housing and displayed on the large housing combination displays;

Switching between displays is controlled by a switching device connected to the host computer;

Each display is connected to at least two or more computer mainframes, and each screen display has a computer switching screen to switch between computers; and

When at least two or more computer hosts share the same set of monitors, they need to switch between the keyboard, monitor, or mouse by using the switching device of the individual computer host.

Presently, a peripheral device is used as a switching device, so that the peripheral device is directly connected to the computer host. The keyboard, the display, and the mouse are connected to the peripheral device and either the keyboard, the display, or the mouse are used for switch control.

However, the current peripheral device must be re-read when connecting to a host computer. When switching from one computer host to another computer host, the computer host must re-recognize the device. In order for the peripheral device to be used, time is wasted when switching between computer hosts.

Also, for the various peripheral devices currently on the market, the compatibility of different peripheral devices affects the switching updates, which must be frequently performed. This reduces the flexibility and applicability of the system in response to different peripheral devices.

It can be seen that there are still many disadvantages to the conventional devices which are not designed well and need to be improved. Therefore, the speed, flexibility, and efficiency of switching can be effectively improved by innovative hardware design.

### SUMMARY OF THE INVENTION

An objective of the present invention is to solve the problems and overcome the disadvantages of the conventional solutions in order to effectively improve the speed of switching by the peripheral device and increase the flexibility and applicability of the product.

In order to achieve the above object and more, the present invention provides a signal transmission control system, which can maintain the connection state of each computer by connecting a plurality of external devices with each computer, so as to effectively improve performance when the display device is switched, increase the switching speed, and provide the ability of the external device to simultaneously transmit connection information to multiple hosts and communicate with each other for each type of external devices in order to increase product interoperability and flexibility in various applications.

Another object of the present invention is to solve the operation procedure for simplifying the use of a command by a general external device, and to use an analysis data report to confirm the data format transmitted by the external device, thereby achieving the function of effective switching between external devices instead of the computers.

To achieve the above objectives and more, the present invention provides an electronic signal transmission control system comprising a plurality of hosts connected to a transmission control system. The transmission control system comprises a plurality of command data modules respectively associated with and correspondingly connected to the plurality of hosts, and extract execution command data of the host.

A plurality of address conversion modules are respectively connected to the command data module, and convert data into an electronic signal by utilizing the command data captured by the command data module.

A control engine module comprises an address control module and a processing module, wherein the address control module receives the electronic signal converted by the address conversion module and analysis is performed by the processing module.

An application interface module comprises a hot key module, a mouse connecting point module, and a channel converting module.

An integrated processing module transmits the integrated electronic signal to the application interface module.

A data processing module receives an execution command issued by an external device, and analyzes and then transmits to the integrated control engine module.

A signal enhancement module is used to enhance the signal strength when transmitted via a mobile module.

In an embodiment of the invention, the hotkey module is configured to set the integrated electronic signal to a hotkey command.

In an embodiment of the present invention, the mouse connecting point module is configured to perform the specified command action by the processing module and integrate the electronic signal by clicking the mouse.

In an embodiment of the present invention, the channel conversion module performs channel conversion by receiving an instruction to operate by the electronic signal after integration.

In an embodiment of the present invention, the data processing module further comprises a data broadcast control module configured to store the data received by the external device via the data conversion module, and to send the data back to the data processing module.

A matrix function control module performs data conversion by receiving an execution command of the external device, and performs an analysis and calculation process of the electronic signal by a matrix equation.

In an embodiment of the invention, the external device is a mouse, a keyboard, or a mobile device.

In an embodiment of the present invention, the mobile module comprises a system hub module, and the execution command of the external device is transmitted to the data processing module through the signal enhancement module via a data conversion module.

The data conversion module performs data conversion on the execution command of the external device, converts the signal of the execution command into matrix function data, and transmits the signal to the data processing module through the signal enhancement module for calculation and analysis.

In an embodiment of the present invention, the external device is a single external device or an external device with a pivoting port.

The present invention further comprises an electronic signal transmission control method comprising:
Step 1, executing an external device plug-in program;
Step 2, executing a host plug-in program; and
Step 3, setting the host to an address conversion module.

In an embodiment of the present invention, the external device plug-in program comprises:
Step a, controlling module initialization, and providing an electronic signal to the control engine module by the address conversion module;
Step b, the address control module sets the address instruction, so that the system hub module gives the same address;
Step c, determining, by the data processing module, a command of “acquiring the state of the external device” to find whether the system hub module is connected to the external device;
Step d, if no, return to Step c to re-determine, if yes, issue a “device status” setting request to obtain an execution command of the external device, and determine whether an external device is in a normal state; and
Step e, if no, the device is initialized. If yes, the control engine module is connected.

In an embodiment of the present invention, the host plug-in program comprises:
Step a, the host transmits the execution command data to the command data module, and then the address conversion module converts the command data into an electronic signal;
Step b, the control engine module performs initialization, and sets the system device host location;
Step c, determining, by the data processing module, a command of “acquiring an external device state” to determine whether the external device is connected;
If the external device is not connected return to Step c to re-determine;
Step d, if yes, determine whether the state of the external device is normal,
Step e, if yes, connect with the device and determine whether the connection is successful; and
Step f, if no, the host performs initialization on the device, and if yes, the host performs initialization on the external device.

In an embodiment of the present invention, in Step c, the determining whether the external device is connected, comprises:
Step a, the host device performs device information comparison according to the signal transmission time between devices to obtain the final data;
Step b, according to the device information of the majority host, comparing the starting time of each host;
Step c, the control engine module performs device information comparison according to the signal transmission time of the external device to obtain the final device data, and then arranges according to the order of the data; and
Step d, according to the order of the data, responding to the signal transmission time command of the external device of the host.

In an embodiment of the present invention, the setting host to address conversion module comprises:
Step a, receiving, by the command data module, execution command data of the host;
Step b, searching for an engine code by using the host address and the host code table;
Step c. simultaneously searching for the device address by using the engine code and the device code;
Step d. modify the execution command data of the host to the device location, and then send the data to the device; and
Step e, receiving the data with the host bit only responding to the host.

In an embodiment of the present invention, the host code is obtained by setting an application interface to obtain a parameter of the host code, where:
Step a, the address control module receives the execution command data of the host;
Step b: find, by using the host address, whether the host code can be executed;
Step c. if no, the reply host rejects;
Step d, if yes, searching for the device address by using the engine code and the device code;
Step e, modifying the execution command data of the host to the device location, and then sending the data to the device; and
Step f, receiving the data with the host bit only responding to the host.

### BRIEF DESCRIPTION OF THE DRAWINGS

FIG. 1 is a block diagram illustrating structure of an electronic signal transmission control system and method thereof according to an embodiment of the present invention;

FIG. 2 is a flowchart of an electronic signal transmission control system and method thereof according to an embodiment of the present invention;

FIG. 3 is a flowchart of an external device plug-in program of the electronic signal transmission control system and method thereof according to an embodiment of the present invention;

FIG. 4 is a flowchart of a host plug-in program of the electronic signal transmission control system and method thereof according to an embodiment of the present invention;

FIG. 5 is a flowchart of setting a host-to-address conversion module of the electronic signal transmission control system and method thereof according to an embodiment of the present invention;

FIG. 6 is a flowchart of obtaining parameters of the host code of the electronic signal transmission control system and method thereof according to an embodiment of the present invention;

FIG. 7 is a flowchart of determining whether an external device has been connected of the electronic signal transmission control system and method thereof according to an embodiment of the present invention; and

FIG. 8 is a diagram illustrating data broadcasting of the electronic signal transmission control system and method thereof according to an embodiment of the present invention.

### DESCRIPTION OF THE PREFERRED EMBODIMENTS

To understand the technical features, contents, and advantages of the present invention and the effects thereof, the present invention will be described in detail with reference to the accompanying drawings, in which the scope of the present invention is clarified. The scope of the invention is described first.

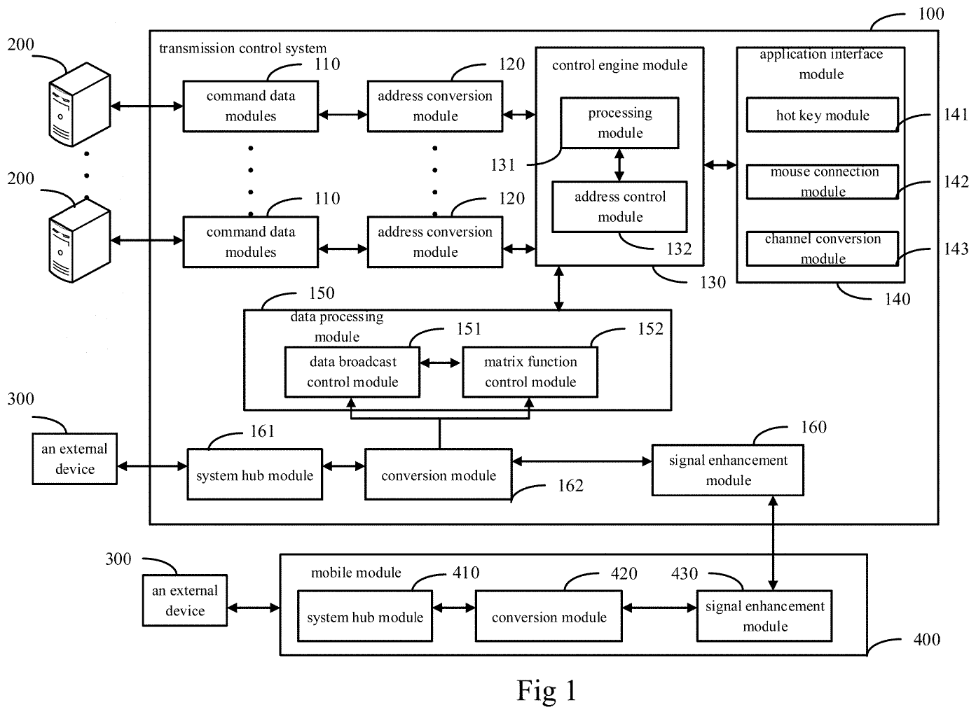

Refer to FIG. 1. The electronic signal transmission control system of the present invention comprises a plurality of hosts (200) connected with a transmission control system (100).

The transmission control system (100) comprises a plurality of command data modules (110), respectively connected to the plurality of hosts (200), for retrieving execution command data of the host.

An address conversion module (120) is respectively connected to the command data module (110), and converts data into an electronic signal by executing the command data retrieved by the command data module (110).

A control engine module (130) comprises an address control module (132) and a processing module (131), wherein the address control module (132) is configured to receive the electronic signal converted by the address conversion module (120), and the processing module (131) performs analysis and integration.

An application interface module (140) comprises a hot key module (141), a mouse connection module (142), and a channel conversion module (143) in communication with the processing module (131). The electronic signal is transmitted to the application interface module (140) for execution, wherein the hot key module (141) is configured to set the integrated electronic signal to the hot key command by the processing module (131).

The mouse connecting module (142) is configured to enable the processing module (131) to perform the specified command action by selecting the integrated electronic signal, and the channel converting module (143) is configured to receive the electronic signal. The processing module (131) converts the integrated electronic signal by channel action and/or command action.

A data processing module (150) receives an execution command issued by an external device (300), and performs calculation and analysis and then transmits data to the control engine module (130) for integration, wherein the data processing module (150) further comprises a data broadcast control module (151).

A matrix function control module (152) is configured to interact with the external device (300) and execute a command to perform data conversion and performs an electronic signal analysis and calculation process by using a matrix equation.

A signal enhancement module (160) is configured to enhance the signal strength when transmitted with a mobile module (400). The digital signal is enhanced to increase the signal transmission distance and the use of a network transformer (Ethernet Transformer) to provide a larger bandwidth to transmit higher speed data, wherein the mobile module (400) comprises a system hub module (410).

A data conversion module (420) transmits the execution command of the external device (300) to the data processing module (150) through the signal enhancement module (430).

A data conversion module (420) performs data conversion, converts the signal of the execution command into matrix function data, and transmits the signal to the data processing module (150) for calculation and analysis through the signal enhancement module (160), wherein the external device (300), the mouse, the keyboard, the mobile device, and the like can be connected by a signal to control the computer to perform an action.

In an embodiment the external device (300) is a single external device having an external device with a pivoting port.

The transmission control system(100) comprising further comprising a system hub module (161) for transmitting the execution command of the external device (300) to the data processing module (150) through the via a data conversion module (162); and

the data conversion module (162)for performing data conversion on the execution command of the external device (300), converting the electronic signal of the execution command into matrix function data, and transmitting the electronic signal to the data processing module (150) through for calculation and analysis.

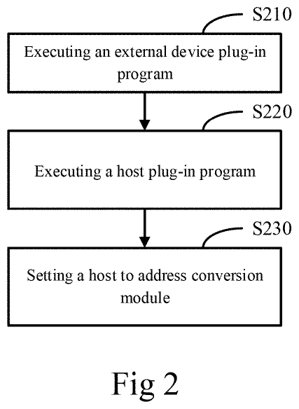

Refer to FIG. 2, which is a flowchart of the electronic signal transmission control system and method thereof according to an embodiment of the present invention. The method comprises:
Executing an external device plug-in program in Step S210;
Executing a host plug-in program in Step S220; and
Setting a host to address conversion module in Step S230.

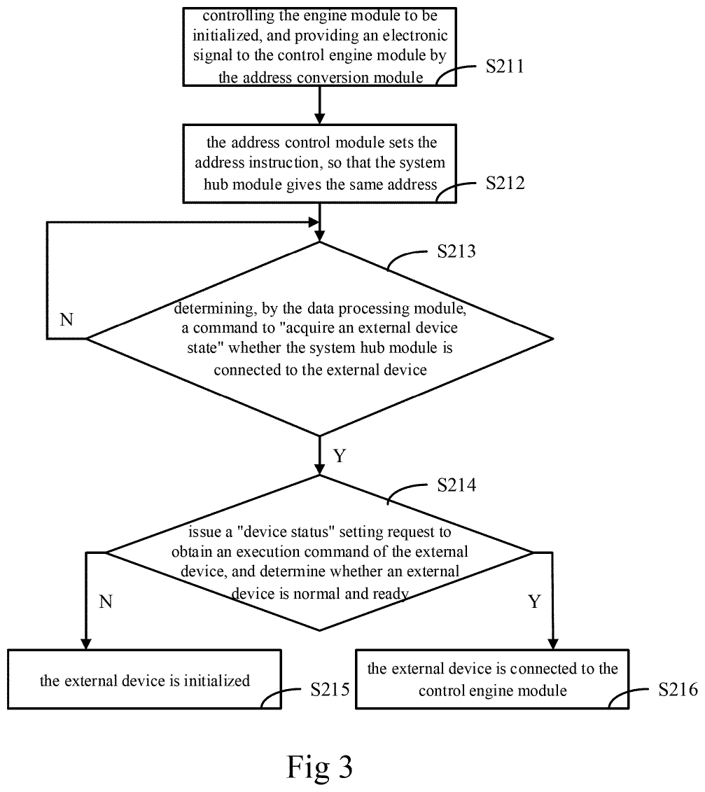

Refer to FIG. 3. Step S210 of FIG. 2 comprises:
In Step S211, controlling the engine module to be initialized, and providing an electronic signal to the control engine module by the address conversion module;
In Step S212, the address control module sets the address instruction, so that the system hub module gives the same address;
In Step S213, determining, by the data processing module, a command to “acquire an external device state” whether the system hub module is connected to the external device;
If no, return to Step S213 to re-determine;
If yes, then in Step S214 issue a “device status” setting request to obtain an execution command of the external device, and determine whether an external device is normal and ready; and
If no, then in Step S215 the external device is initialized, and if yes, in Step S216 the external device is connected to the control engine module.

In Step S215 the device is initialized, the external device is set as the device address by the control engine module, and the device address of the external device is reset, and an establishment request is issued to request the use of the endpoint to obtain the cycle time.

In Step S216 the device is connected to the control engine module, to set n+1 hub codes, and set a host address to pre-set a hierarchical position to be the same as the host position and use the “SetAddress” directive to assign some hierarchical locations.

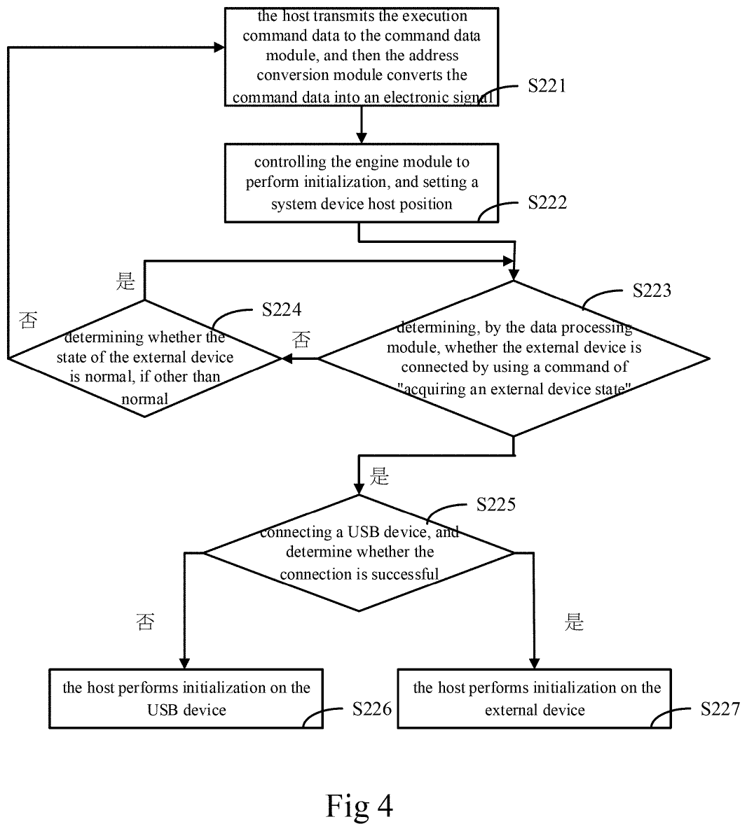

Refer to FIG. 4. Step S220 of FIG. 2 comprises:
In Step S221, the host transmits the execution command data to the command data module, and then the address conversion module converts the command data into an electronic signal;
In Step S222, controlling the engine module to perform initialization, and setting a system device host position;
In Step S223, determining, by the data processing module, whether the external device is connected by using a command of “acquiring an external device state”;
If not, then in Step S224, determining whether the state of the external device is normal, if other than normal, returning to Step S221. If yes, returning to Step S223 to re-determine;
In Step S223, if yes, then in Step S225 connecting a USB device, and determine whether the connection is successful; and
If no, then in Step S226, the host performs initialization on the USB device, and if yes, in Step S227, the host performs initialization on the external device.

In Step S226, when the host performs initialization on the USB device the control engine module sets a Temp_Location_ID, and the host provides a device address, so that the control engine module sets the device address.

In Step S227, when the host performs initialization on the external device, the Temp_Location_ID is set by the control engine module, and the host provides an address of the external device, so that the control engine module sets the external device address.

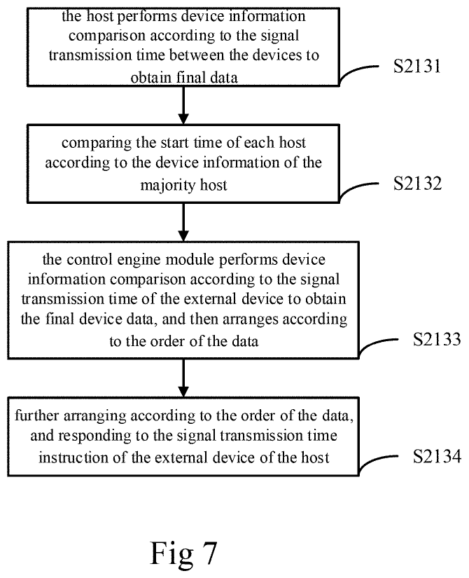

Refer to FIG. 7. In Step S223 of FIG. 4, determining whether the external device is connected, comprises:

In Step S2131, the host performs device information comparison according to the signal transmission time between the devices to obtain final data;
In Step S2132, comparing the start time of each host according to the device information of the majority host;
In Step S2133, the control engine module performs device information comparison according to the signal transmission time of the external device to obtain the final device data, and then arranges according to the order of the data; and
In Step S2134, further arranging according to the order of the data, and responding to the signal transmission time instruction of the external device of the host.

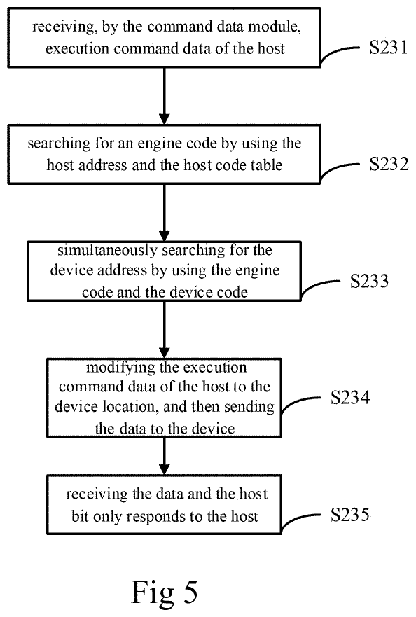

Refer to FIG. 5. Step S230 of FIG. 2 comprises:
In Step S231, receiving, by the command data module, execution command data of the host;
In Step S232, searching for an engine code by using the host address and the host code table;
In Step S233, simultaneously searching for the device address by using the engine code and the device code;
In Step S234, modifying the execution command data of the host to the device location, and then sending the data to the device; and
In Step S235, receiving the data and the host bit only responds to the host.

In the above host address, please refer to Table 1 (Host1 Location Table):

TABLE 1

| Host 1 | | Location_ID | | | |
|---|---|---|---|---|---|
| assign | Location_ID | Hub | Hub Port | Enable/ | Note |
| Address | Value | Number | Number | Disable | (Device) |
| 3 | 10 | 1 | 0 | Enable | System Hub |
| 5 | 11 | 1 | 1 | | Mouse 1 |
| 6 | 13 | 1 | 3 | | Keyboard |
| 8 | 20 | 2 | 0 | | External Hub 1 |
| 12 | 22 | 2 | 2 | | Touch Panel |
| 13 | 23 | 2 | 3 | | Joystick |
| 2 | 30 | 3 | 0 | | External Hub 2 |
| 7 | 32 | 3 | 2 | | Mouse 2 |

In the above host address, please also refer to Table 2 (Host2 Location Table):

TABLE 2

| Host 2 | | Location_ID | | | |
|---|---|---|---|---|---|
| assign | Location_ID | Hub | Hub Port | Enable/ | Note |
| Address | Value | Number | Number | Disable | (Device) |
| 2 | 10 | 1 | 0 | Enable | System Hub |
| 6 | 11 | 1 | 1 | | Mouse 1 |
| 5 | 13 | 1 | 3 | | Keyboard |
| 9 | 20 | 2 | 0 | | External Hub 1 |
| 11 | 22 | 2 | 2 | | Touch Panel |
| 12 | 23 | 2 | 3 | | Joystick |
| 13 | 30 | 3 | 0 | | External Hub 2 |
| 7 | 32 | 3 | 2 | | Mouse 2 |

In the above device address, please refer to Table 3 (Device Location Table):

TABLE 3

| | | Location_ID | | |
|---|---|---|---|---|
| Control Engine | Location_ID | Hub | Hub Port | Note |
| assign Address | Value | Number | Number | (Device) |
| 1 | 10 | 1 | 0 | System Hub |
| 2 | 11 | 1 | 1 | Mouse 1 |
| 3 | 13 | 1 | 3 | Keyboard |
| 4 | 20 | 2 | 0 | External Hub 1 |
| 5 | 22 | 2 | 2 | Touch Panel |
| 6 | 23 | 2 | 3 | Joystick |
| 7 | 30 | 3 | 0 | External Hub 2 |
| 8 | 32 | 3 | 2 | Mouse 2 |

Wherein the Host 1 assign address of Table 1 and the Host 2 assign address of Table 2 are generated by each host, and therefore are not necessarily the same, but Table 1 and Table 2 (Host Location Table) and Table 3 the Location ID Value of the Device Location Table is the same. Therefore, when the Location_ID Value of Table 1 and Table 2 (Host Location Table) and Table 3 (Device Location Table) are the same, the Address Number set by Host can be mapped to the control Address Number set by the engine module.

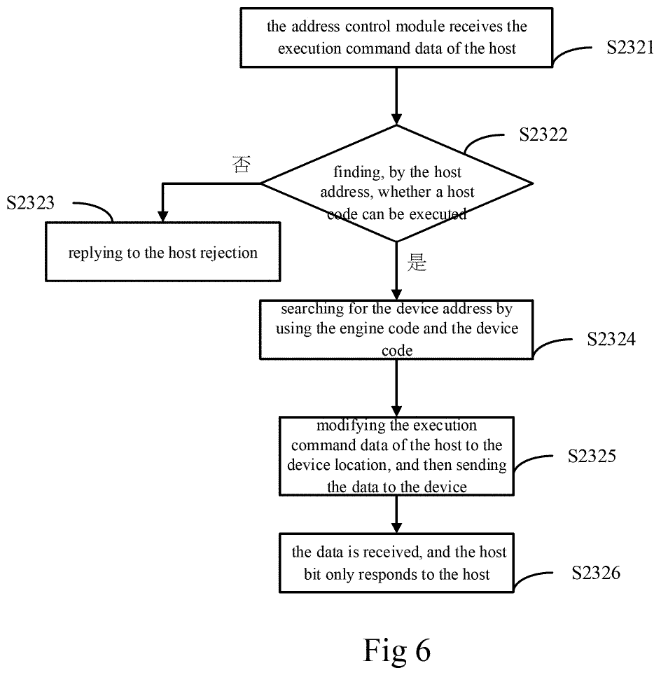

Refer to FIG. 6. According to the host code of Step S230, the parameter of the host code is obtained by setting the application interface, the steps comprising:
In Step S2321, the address control module receives the execution command data of the host;
In Step S2322, finding, by the host address, whether a host code can be executed;
If no, then in Step S2323, replying to the host rejection;
If yes, then in Step S2324, searching for the device address by using the engine code and the device code; and

In Step S2325, modifying the execution command data of the host to the device location, and then sending the data to the device; and
In Step S2326, the data is received, and the host bit only responds to the host.

The matrix function control module performs the analysis and calculation processing of the electronic signal by the matrix equation, and uses functional settings, such as hotkey commands or remote program settings, to set available or unavailable parameters of the host address.

The analysis and calculation process comprises:
In Step a., the matrix function control module receives the setting, input or output instruction of the host;
In Step b., querying the available or unavailable parameters of the host code table by using the host address;
In Step c., if it is unavailable, the reply host is unavailable;
In Step d., if available, query the device address by using the host code and the device code;
In Step e., converting the setting, input or output command of the host into a bit address code, and transmitting the code to the device; and

In Step f, relaying the data received by the device to the host with the host address.

The matrix equation is:

C=A×B=(X1×Y1)+(X2×Y2)+(X3×Y3)+ . . . +(Xn×Yn)

and the processing of the calculation is performed.

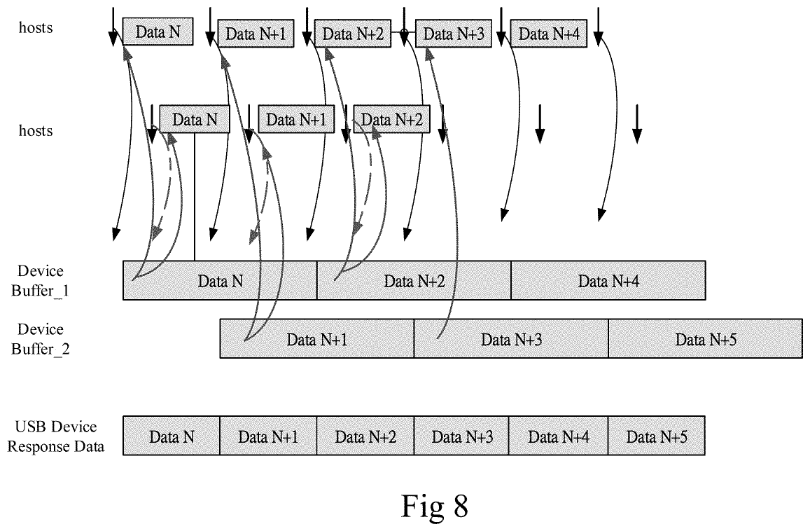

Refer to FIG. 8. The host will fix the endpoint for a period of time to poll the device. The fixed period of time is determined according to the interval of the device under the USB standard, wherein the start time of the polling is not the same for the plurality of hosts.

The control engine module will poll the device according to the interval time of the device to obtain the endpoint data of the device, and then according to Device Buffer_1, Buffer_2, Buffer_1, Buffer_2, Buffer_1 . . . The order is placed in response to the host polling data command, which is also set according to Device Buffer_1, Buffer_2, Buffer_1, Buffer_2, Buffer_1.

The host performs a setting, input or output command, a setting response, input or output, and the transmission element sent to the mobile device by the signal enhancement or conversion method, and then transmitted to the external device through the data command converted to an external device signal number and connected to other external devices to extend the connection distance of the external device.

The present invention simplifies the operation of the application interface module to set the hot key module, the mouse connecting point module, and the channel converting module. The implementation manner is as follows:

The hotkey module switches to the corresponding function or interface by selecting the set button by the keyboard. For example, pressing the F3 key of the keyboard, the system switches to function 3, and according to the variety of keyboards, the keyboard code setting is not exactly the same. The data will be analyzed from the device report data to analyze the key data of the keyboard to set the key code of the hot key. When the control engine module receives the keyboard data, it compares with the set hot key code. When the data is the same the hotkey function setting program is entered and the hotkey function setting program enters the channel setting,

The channel setting code is stored, and when the keyboard input data is compared with the channel setting code, the channel is switched to the set channel.

The mouse connecting point module has a variety of mouse types, and the mouse code data setting is not completely the same. By analyzing the device report data for the mouse, the mouse wheel information is retrieved. When the mouse wheel is moved or selected, the action triggers a channel change, and the system switches to the next channel, that is, the channel change is completed.

The channel conversion module applies the data transmitted when the mouse moves to switch the host channel. When the mouse moves, the data transmitted is mostly the relative position, and the mouse is moved to the edge of the screen to switch the host channel. The device report data for the mouse is analyzed to get the mouse movement data, and then with the size of the screen, when the mouse moves to the edge of the screen, it automatically switches the host channel.

The action program is as follows:
Set the resolution of the host screen and the data at the edge of the screen;
Set an external device (i.e. mouse) that can transmit absolute position data.
The position of the external device is set to the initial data (‘0’ or the middle position of the screen);
The device report data for the mouse is analyzed to obtain the location data transferred when the mouse moves;
The movement data from not moving the mouse is changed to 0 (indicating that mouse does not move) and then sent back to the host;
The data moved by the mouse is transmitted to the host by the existing location of the external device; and
Check if the existing location of the external device has exceeded the edge of the screen, and if it exceeds the edge of the screen, switch to the corresponding host channel.

From the above description, it can be seen that the present invention has the following advantages compared with the prior art.

The present invention can connect a plurality of hosts to devices by an external device (i.e., USB) and simultaneously integrate different information, so as to integrate external devices of different brands at the same time.

The present invention simplifies the complicated procedures and inconveniences when switching channels by simplifying the application interface module programming.

The present invention can perform channel switching of multiple hosts by a single external device by simplifying the application interface module.

In summary, the electronic signal transmission control system and method of the present invention can achieve the intended efficiency by the above disclosed embodiments. Also, the present invention has not been disclosed in the prior art.

The illustrations and descriptions of the present invention are merely preferred embodiments of the present invention, and are not intended to limit the scope of the present invention. Other equivalent variations or modifications are considered to be within the scope of the design of the invention.

What is claimed is:

1. An electronic signal transmission control system comprising:
a plurality of hosts connected to a transmission control system;
the transmission control system comprising:
a plurality of command data modules respectively connected to the plurality of hosts for receiving execution command data from the plurality of hosts;
a plurality of address conversion modules respectively connected to the plurality of command data modules for converting received command data from the plurality of command data modules into an electronic signal;
a control engine module comparing an address control module and a processing module, wherein the address control module receives the electronic signal converted by the address conversion module and the processing module analyzes and integrates the electronic signal;
an application interface module comprising a hot key module, a mouse connecting point module, and a channel converting module, the application interface module receiving the electronic signal transmitted by the processing module;
a data processing module for receiving an execution command issued by an external device, and then performing calculation and analysis, and then transmitting data to the control engine module for integration; and
a signal enhancement module for enhancing the signal strength of the electronic signal when transmitted via a mobile module.

2. The electronic signal transmission control system of claim 1, wherein the hotkey module is configured to set the integrated electronic signal to a hotkey command.

3. The electronic signal transmission control system of claim 1, wherein the mouse connecting point module initiates integration of the electronic signal by the processing module by clicking a mouse button or wheel.

4. The electronic signal transmission control system of claim 1, wherein the channel conversion module performs channel change by receiving an instruction to receive the integrated electronic signal from the processing module.

5. The electronic signal transmission control system of claim 1, the data processing module further comprising:
a data broadcast control module for storing data received by the external device via the data conversion module and transmitting the data back to the host; and
a matrix function control module for performing data conversion by receiving an execution command, and performing an analysis and calculation process of the electronic signal using a matrix equation.

6. The electronic signal transmission control system of claim 1, wherein the external device is a mouse, a keyboard, or a mobile device.

7. The electronic signal transmission control system of claim 1, the mobile module comprising:
a system hub module for transmitting the execution command of the external device to the data processing module through the signal enhancement module via a data conversion module; and
the data conversion module for performing data conversion on the execution command of the external device, converting the electronic signal of the execution command into matrix function data, and transmitting the electronic signal to the data processing module through the signal enhancement module for calculation and analysis.

8. The electronic signal transmission control system of claim 1, the transmission control system comprising further comprising:
a system hub module for transmitting the execution command of the external device to the data processing module through the via a data conversion module; and
the data conversion module for performing data conversion on the execution command of the external device, converting the electronic signal of the execution command into matrix function data, and transmitting the electronic signal to the data processing module through for calculation and analysis.

9. An electronic signal transmission control method comprising:
executing an external device plug-in program;
executing a host plug-in program; and
setting the host to address conversion module.

10. The electronic signal transmission control method of claim 9, the external device plug-in program comprising:
initializing the control engine module and transmitting an electronic signal to the control engine module by an address conversion module;
setting an address instruction by an address control module so that a system hub module has the same address;
determining, by the data processing module, a command of acquiring a state of the external device whether the system hub module is connected to the external device;
if not connected, re-determining if the system hub module is connected to the external device, if connected issuing a device status setting request to obtain an execution command of the external device, and determining whether a status of the external device is normal; and
if the status is not normal, initializing the external device and if the status is normal, connecting the external device to the control engine module.

11. The electronic signal transmission control method of claim 9, the host plug-in program comprising:
transmitting execution command data to a command data module by a host, and converting command data into an electronic signal by an address conversion module;
performing initialization by a control engine module performs and setting a system device host address;
determining, by the data processing module, a command of acquiring an external device state to determine whether an external device is connected;
if not connected, re-determining whether the external device is connected;
if connected, determining if a state of the external device is normal;
if the state is normal, connect with a USB device and determine whether connection was successful;
If unsuccessful performing initialization on the external device by the host; and
if successful, connecting the external device the control engine module.

12. The electronic signal transmission control method of claim 9, wherein setting of the host to address conversion module comprises:
receiving execution command data of the host by a command data module;
searching for an engine code by using a host address and a host code table;
simultaneously searching for a device address by using the engine code and a device code;
modifying the execution command data of the host to the device address and then sending the data to the device; and
receiving the data with the host bit only responding to the host.

13. The electronic signal transmission control method of claim 12, further comprising:
receiving the execution command data of the host by the address control module;
using the host address to determine whether the execution command data can be executed;
if the execution command data cannot be executed, rejecting the execution command data;
if the execution command data can be executed, searching for the device address by using the engine code and the device code;
modifying the execution command data of the host to the device address and then sending the modified data to the device; and
receiving the modified data with the host bit only responding to the host.

14. The electronic signal transmission control method of claim 11, wherein determining whether the external device is connected, comprises:
performing device information comparison according to signal transmission time between the external device and the device by the host;
according to device information of a majority host, comparing the starting time of each host;
performing device information comparison according to signal transmission time of the external device to obtain final device data, and then arranging according to data order by the control engine module; and
responding to the signal transmission time command of the external device of the host according to the data order.
